(19) United States
(12) Patent Application Publication
(10) Pub. No.: US 2016/0316045 A1
(43) Pub. Date: Oct. 27, 2016

(54) Method for Coding Packet Classification Key Composition Rules Using Variable Length Commands

(71) Applicants: Ron Treves, Kfar Saba (IL); Evgeni Ginzburg, Petah Tikva (IL); Adi Katz, Ramat Gan (IL)

(72) Inventors: Ron Treves, Kfar Saba (IL); Evgeni Ginzburg, Petah Tikva (IL); Adi Katz, Ramat Gan (IL)

(73) Assignee: Freescale Semiconductor, Inc., Austin, TX (US)

(21) Appl. No.: 14/695,118

(22) Filed: Apr. 24, 2015

(51) Int. Cl. H04L 29/06; H04L 12/741

(52) U.S. Cl. CPC H04L 69/22; H04L 45/74

(57) ABSTRACT

A method and apparatus are provided for classifying received network frames (106) by using a key composition rule (134) having a header portion (NF) and multiple variable length key extract commands in a coded order sequence to sequentially generate multiple data fields (FIELD 1-FIELD n) using operands contained in the key extract commands to generate a lookup key (116) by combining multiple data fields in the same coded order sequence as the key extract commands.

### BACKGROUND OF THE INVENTION

1. Field of the Invention

The present invention is directed in general to data processing of network packet communications. In one aspect, the present invention relates to a method, apparatus, system, and computer program product for processing frames.

2. Description of the Related Art

Existing digital communication networks transport large amounts of information data (e.g., voice, facsimile, television, audio, and/or video data) using network frames to convey the information data in accordance with various communication protocols which typically define dedicated fields as part of each frame header which may be parsed to determine or classify the type of the frame (which communication protocol) and then processed in response to the frame classification. Frame classification conventionally employs multiple policy lookup tables for processing frames, where each lookup table is accessed with a lookup key. A typical classification flow may require multiple lookup table operations, each requiring its own lookup key which is composed of fields extracted from the frame header or some other data vector. For example, a first received frame may be parsed, and based on instructions from key composition rules, source and destination addresses may be extracted, combined, and applied as a first table lookup key to produce a lookup result. This result can then be used in some logical combination with more frame header fields or parsed information to produce another lookup key to be used in another lookup search at one or more lookup tables.

To generate the structure and composition of a lookup key, a key composition rule may designate the desired fields to be extracted and combined in a specific order to thereby control the combination of predetermined fields or tuples (and/or other data fields) to be extracted from a received frame or other data vector into the generated lookup key. However, existing approaches for generating lookup keys use fixed-length key composition rules to construct lookup keys using standard configuration registers holding a fixed number of masks which may be optionally applied on data which is extracted using a fixed extraction sequence.

As seen from the foregoing, existing approaches for generating lookup keys are highly structured in terms of the rule format and field extraction, inflexible in terms of being unable to programmably generate lookup keys having different sizes or field structure sequences, and/or inefficient in terms of required processing resources, configuration registers and footprint so that the existing solutions for generating lookup keys used in classifying and processing frames are extremely difficult at a practical level.

### BRIEF DESCRIPTION OF THE DRAWINGS

The present invention may be understood, and its numerous objects, features and advantages obtained, when the following detailed description is considered in conjunction with the following drawings.

FIG. 1 illustrates a simplified schematic block diagram of a system for processing classification of network frames using a key composition rule with variable length field extraction commands to code a table lookup key in accordance selected embodiments of the present disclosure.

FIG. 2 illustrates a key composition rule structure in accordance with selected embodiments of the present disclosure.

FIG. 3 illustrates how an extract command provides the point, offset, and extract size for extracting a data structure from a frame header in accordance with selected embodiments of the present disclosure.

FIG. 4 illustrates a simplified process flow chart sequence for processing a frame in accordance with selected embodiments of the present disclosure.

### DETAILED DESCRIPTION

A key composition device, system, and methodology are described for using variable length Field Extract Commands (FECs) in a key composition rule to programmably and flexibly code a table lookup key with inserted data fields having the same order sequence as the corresponding FECs for accessing a shared lookup table. In selected embodiments, a key composition rule structure is defined to include a first header value and a plurality of variable length FECs, where the first header value declares the number of trailing FECs, and where each FEC includes defined operands specifying the type of data being extracted, the method by which to calculate the location from which the data should be extracted, and/or the number of operands in the FEC. In other embodiments, an FEC in a key composition rule may also define one or more masks with associated mask offset values to control application of the mask(s) to the extracted data inserted into the table lookup key. When the decoder decodes an FEC, the decoder provides a feed of extracted parameters and control information to a pipelined engine and may calculate the location of the next FEC in the key composition rule. The pipelined engine generates multiple data fields using pipelined hardware logic to extract the data fields from the frame.

In operation, a received frame is parsed to generate frame metadata to be provided with the frame for further processing. A key generation engine receives frames and associated frame metadata to generate classification keys based on defined key composition rules. In accordance with the present disclosure, a key composition rule is defined with one or more variable length field extract commands which are ordered in the rule to define the order at which fields from a frame header are placed into a lookup key. The defined key composition rule may also include information specifying the number of field extract commands in the rule. Each variable length field extract command contains information such as the type of data being extracted, the location of the data source for such data, and whether a mask shall be applied to the extracted data. Using field extract commands, a key composition rule may generate a classification key with increased efficiency and versatility while reducing the number of required configuration registers. The generated classification key is then used to perform a table lookup and return a frame classification result for the received frame.

With the disclosed key composition rule and associated approach for generating classification keys, a large number of fields may be inserted into the classification key with a user-controlled sequence to achieve any desired ordering with an efficient and low cost hardware solution to increase the versatility and simplicity of the key generation process. In addition, the ability to control the field sequence in a classification key enables the performance of reverse searches using the same lookup tables by simply switching the sequence of fields in the classification key. The need for configuration register resources and associated circuit space and power consumption are also reduced or eliminated by providing a coding approach for determining the sequence of fields used in a classification key. The disclosed key composition rule and associated approach for generating classification keys also provides an efficient mechanism for sizing and scaling key composition rules in a consistent manner.

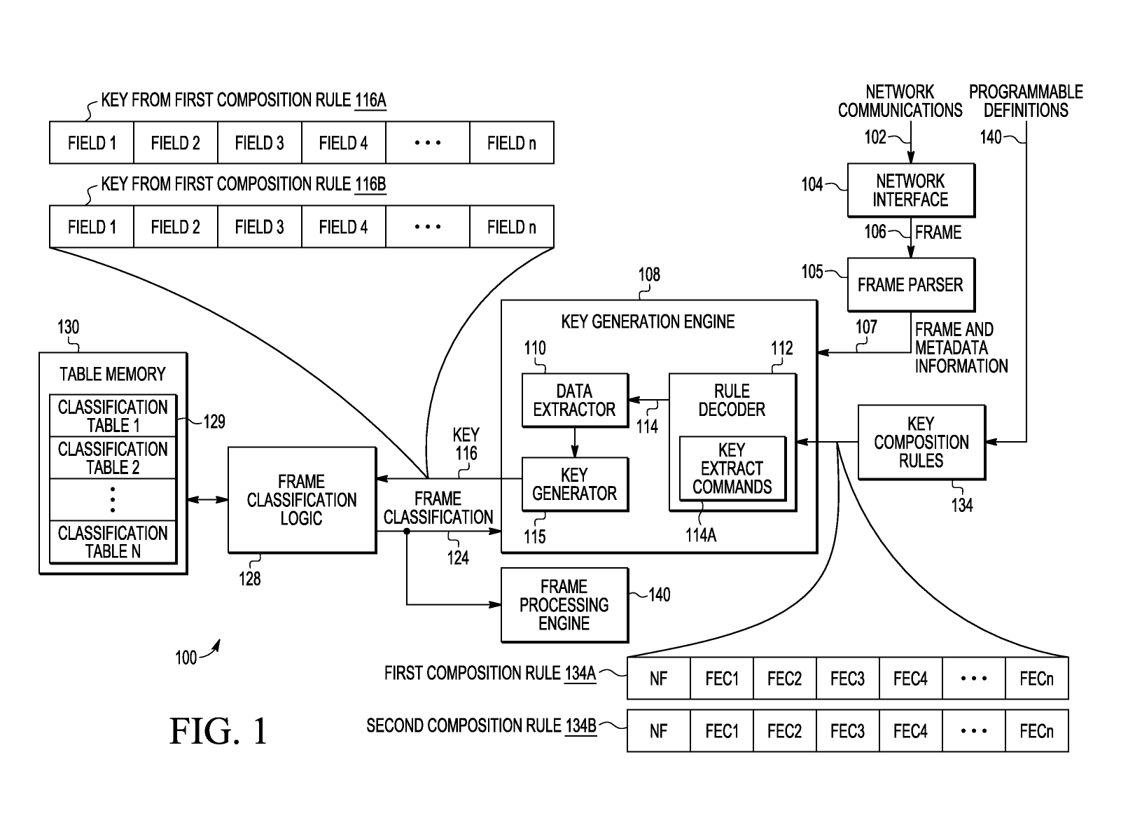

Turning now to FIG. 1, there is shown a simplified schematic block diagram of a system 100 for generating table lookup keys which may be embodied as a key generation and table lookup mechanism for processing frames and producing classification results in accordance selected embodiments of the present disclosure. A network interface 104 receives network communications 102, such as network packets or other network communications. Network interface 104 provides one or more network frames 106 associated with the network communications 102 to a frame parser 105. Frame parser 105 then parses the contents of each frame 106 and generates metadata associated with the frame 106. The metadata can include a variety of information related to the processed frames such as, for example, pointers to frame header fields, port numbers, traffic classes, and/or other information related to the frames and the frame contents. The frame data and the generated metadata can be stored within a data storage medium such as a frame buffer, if desired. After parsing the frames and generating the metadata associated with the frames, the frame parser 105 forwards the frame and metadata information 107 to key generation engine 108.

The key generation engine 108 generates a key 116 based upon data extracted from the frames and metadata information 107. The key generation engine 108 includes a rule decoder 112, data extractor 110, and key generator 115. The data extracted by data extractor 110 from the network frames and related metadata information 107 and coded into the lookup key 116 is based upon the key composition rules 134 which are decoded by the rule decoder 112 to execute key extract commands 114 contained in each key composition rule 134. As described more fully below, the rule decoder 112 sequentially decodes one or more Field Extract Commands (FECs) or Generic Extract Commands (GECs) from a key composition rule 134, and the key generator 115 generates the key 116 based upon the data extracted using these key extract commands. The key composition rules 134 can be defined by users through user programmable definitions 133 to include a first value and a plurality of variable length key extract commands, where the first value specifies the number of trailing key extract commands, and where each key extract command includes defined operands specifying the type of data being extracted, information, such as a pointer, offset, and extract size) for calculating the location and size of the data to be extracted, and/or the number of operands in each key extract command.

The key 116 generated by the key generation engine 108 is provided to the frame classification logic 128. The frame classification logic 128 performs a table lookup search using the key 116 to search for data within frame classification tables 129 in the table memory 130, and to identify and generate a frame classification 124 for each received frame 106. With this arrangement, the frame classification logic 128 may perform a search on the lookup table 129 by supplying the lookup key 116 as an input search term to determine whether a match exists. In the event the search yields a match, the corresponding output field associated with the matching input search address is retrieved from the lookup table 129 for further processing. In selected embodiments, the lookup search result is a classification result which can be used for updating data fields and then generating a new lookup key, and or which may be concatenated with other key values and/or employed as the basis for a further search of the search field of another lookup table search. For example, the frame classification 124 and the frame and metadata information 107 may then be provided to the key generation engine 108 and/or the frame processing engine 140. The frame classification 124 can include, for example, an indication that the frame is a data frame, an audio/video frame, a high priority frame, a low priority frame, and/or any other frame classification type. The frame processing engine 140 uses the frame result information 124, which includes the classified frame and metadata information, to determine how to process each of the received frames 106. In operation, the frame classification logic 128 can be configured to perform one or more table lookups to the frame classification tables 129 using the key 116 that is generated for the frame 106 by the key generation engine 108.

For purposes of illustrating the logical linkage between example key composition rules 134 and the lookup keys 116 generated thereby for use in accessing one or more lookup tables 130, each key composition rule 134A/B is shown with a data structure having a first header portion NF and one or more FECs. For example, a first key composition rule 134A may include a first header portion NF which contains information specifying the number of fields to be extracted or that there are n FECs included in the rule, and may also include n FECs which are sequenced in a user-selected order. For example, the first key composition rule 134A includes an ordered sequence of n FECs, namely FEC1, FEC2, FEC3, FEC4 . . . FECn. At the rule decoder 112, the sequence of FECs in the first key composition rule 134A may be sequentially decoded as instructions or commands so that, for each FEC, the Data Extractor 110 included in the Key Generation Engine 108 inserts one or more specified header fields identified by the FEC into a classification key (e.g., key 116A). To this end, the first field extract command FEC in rule 134A may include at least a first identifying header portion (specifying the command type and/or length of the FEC) and one or more operand fields which specify the type of field or other data vector to be extracted and placed in a first field position FIELD 1 of the key 116A. In similar fashion, the second field extract command FEC2 in rule 134A may include an identifying header portion and one or more operand fields which specify the type of field or other data vector to be placed in a second field position FIELD 2 of the key 116A, and so on until all field positions FIELD 1, FIELD 2, FIELD 3, FIELD 4 . . . FIELD n are, respectively, placed in the key 116A under control of the sequential field commands FEC1, FEC2, FEC3, FEC4, . . . FECn.

To illustrate how the sequence of fields in the lookup key may be controlled by the sequencing of field extract commands in the lookup key, reference is now made to the second key composition rule 134B which includes a first header portion NF (specifying the number of FECs included in the rule) and one or more FECs which are sequenced in a user-selected order. In the example of the second key composition rule 134B, the ordered sequence of FECs is FEC4, FEC2, FEC1, FEC3, . . . FECn. At the rule decoder 112, the sequence of FECs in the second key composition rule 134B sequentially decoded as instructions or commands by the Data Extractor 110 to insert, for each FEC, the one or more specified header fields identified by the FEC into a classification key (e.g., key 116B). In particular, the rule decoder 112 executes the first field extract command FEC4 in rule 134B by decoding at least a first identifying header portion (specifying the command type and/or length of FEC4) and one or more operand fields which specify the type of field or other data vector to be extracted and placed in a first field position FIELD 4 of the key 116B. In similar fashion, the second field extract command FEC2 in rule 134B is executed to decode the identifying header portion and one or more operand fields which specify the type of field or other data vector to be placed in a second field position FIELD 2 of the key 116B, the third field extract command FEC1 in rule 134B is executed to decode the identifying header portion and one or more operand fields which specify the type of field or other data vector to be placed in a third field position FIELD 1 of the key 116B, and so on until all field positions FIELD 4, FIELD 2, FIELD 1, FIELD 3 . . . FIELD n are, respectively, placed in the key 116B under control of the sequential field commands FEC4, FEC2, FEC1, FEC3, . . . FECn.

As will be appreciated, there are a number of variations and modifications available for using the FEC-based key composition rules 134 to extract and insert frame header fields into the keys 116. For example, each FEC in a key composition rule (e.g., 134A) may be a variable length instruction or command which is implemented or decoded by the rule decoder 112 as a field extract command (FEC) to define the type of field to be placed in the corresponding key (e.g., 116A), such that, upon decoding of each variable length FEC, one or more opcode commands are executed to extract data from a source (e.g., frame header, vector data, or metadata) and then concatenate the extracted data into a corresponding field position of the key. The resulting key 116 may include an n-tuple of fields FIELD 1-FIELD n which are sequentially extracted from the frame headers with an ordered sequence of field extract commands FEC1-FECn.

It is noted that the frame parser 105, key generation engine 108, the frame classification logic 128, and/or the frame processing engine 140 can be implemented as hardware accelerators, firmware, and/or software using one or more processing devices including controllers, microcontrollers, processors, microprocessors, hardware accelerators, configurable logic devices (e.g., field programmable gate arrays), and/or other processing devices. It is further noted that the composition rules 134 can be stored in one or more data registers and/or other data storage mediums including any desired non-transitory tangible medium that stores data, such as data storage devices, FLASH memory, random access memory, read only memory, programmable memory devices, reprogrammable storage devices, hard drives, floppy disks, DVDs, CD-ROMs, and/or any other non-transitory data storage mediums. Other variations could also be implemented.

The processing of data frames can include, for example, receiving frames, parsing frames, generating lookup keys based on defined key composition rules, performing lookups in one or more lookup tables stored in memory, classifying the data frame based on the lookup table results, identifying the corresponding application data flow that the data frame is associated with, and the like. In support thereof and as described in greater detail hereinbelow, the key generation engine 108, frame parser 105, and frame classification logic 128 may be embodied as hardware accelerators configured to perform application-specific tasks with respect to data packets processed by the frame processing engine 140.

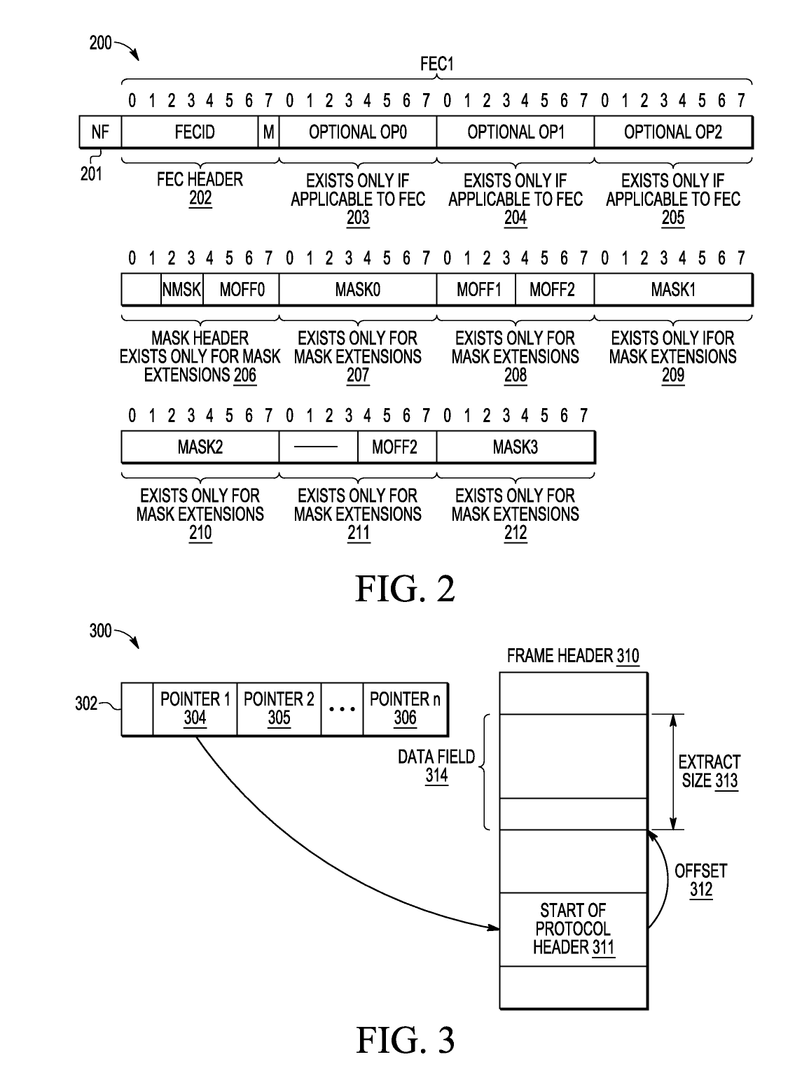

To provide additional contextual understanding for the present disclosure, reference is now made to FIG. 2 which illustrates a key composition rule structure 200 in accordance with selected embodiments of the present disclosure. As depicted, the key composition rule 200 is structured to include a header portion NF 201 followed by one or more Field Extract Commands (FEC) which may be fixed length (e.g., 1 Byte) or variable length. The header portion 201 contains information specifying the number of fields to be extracted or the number of FECs in the rule 200. The sequence of the variable length FECs in the rule 200 determines the order in which the extracted data is placed in the generated key. In addition, each FEC may contain information specifying the type of data being extracted, the method by which to calculate the location from which the data should be extracted, one or more operands used by the FEC, and/or an indication of whether a mask is applied on the extracted data. For example, the key composition rule 200 may include a first field extract command (e.g., FEC1) which includes at least a first FEC header portion 202 and one or more operand fields 203-205 which specify the type of field or other data vector to be extracted and placed in a first field position of the generated key. The first FEC header portion 202 may be structured as a data byte with an FECID field which uniquely specifies the command type of field to be extracted into the key and/or length of the FEC. The first FEC header portion 202 may also include a mask attribute field M designating whether a mask is applied on the data inserted into the key by the FEC. The first field extract command (e.g., FEC1) in the rule 200 may also include one or more optional operand portions or fields 203-205, each of which may be structured as a data byte for storing an operand value (e.g., op0, op1, op2), where each operand value specifies a corresponding field or other data vector to be extracted and placed in the lookup key under control of the first field extract command FEC1. If desired, additional or fewer operand portions or fields may be included in the field extract command.

The disclosed key composition rule 200 may also contain information specifying what masks should be applied on the extracted data when executing an FEC. For example, the first field extract command FEC1 in the key composition rule 200 may include a mask header portion 206 and one or more mask extension fields 207-212 which designate how a mask is applied on the data inserted from the FEC. In such embodiments, the mask header portion 206 may be structured as a data byte with an NMSK field specifying the mask count value NMSK. The mask header portion 206 may also include a first mask offset field MOff0 designating how a first mask MASK0 is applied on the data inserted into the key by the FEC. The mask extension fields 207-212 for the first field extract command (e.g., FEC1) in the rule 200 may each be structured as a data byte for storing the actual mask data operands (MSK0-MSK1) and offset operands (e.g., MOff1, MOff2, MOff3) to be inserted for masking the extracted data. In selected embodiments, the additional mask operand portions or fields may include m additional pairs of header/operand portions which respectively specify the actual mask and offset of each mask (e.g., MOff0 and MSK0, MOff1 and MSK1, MOff2 and MSK2, . . . MOffm and MSKm) from the beginning of the data to be inserted. In an example embodiment, each mask is applied using a 1 byte mask data operand (e.g., MSKᵢ) and an offset operand (e.g., MOffᵢ) designating the location with respect to the start of the extracted data, at which the mask shall be applied.

The disclosed key composition rule 200 may be sized and scaled to include any desired number of FECs. For example, the key composition rule 200 may include one or more additional field extract commands (e.g., FEC2, FEC3) which are sequenced in order to control the placement of data into the key, where each field extract command may include a corresponding FEC header portion and one or more optional operand portions or fields. Following the sequence of variable length FECs (FEC1, FEC2) in the key composition rule 200, the operand(s) in each variable length field extract command may be decoded at the rule decoder 112 to issue an extraction command 114 to the data extractor 110 for inserting the field or other data vector specified by the operands into a key. As described above, a key generation engine analyzes the key composition rule 100 and extracts the required fields from the Frame Header and other data vectors into a key which will be used for table lookup. When all NF FECs are extracted, the extraction process ends for the current frame, and a new frame and rule can be loaded.

To illustrate a method for accessing and extracting data from a frame header, reference is now made to FIG. 3 which illustrates how a key extract command provides the point, offset, and extract size for extracting a data structure from a frame header in accordance with selected embodiments of the present disclosure. In selected example embodiments, the key extract command may be embodied as a field extract command (FEC) contained in a key composition rule. An FEC of known frame header fields has predetermined implicit set of parameters associated with the FEC which determine the source of the extracted data, the location of the extracted data within the source, and the size of the extracted data. When decoded and executed against known header fields to generate frame header parse results 302 containing one or more pointers 304-306, the executed FEC specifies the location of a first pointer 304 (e.g., Pointer 1) in the frame header parse results 302. At the pointer location 304, a pointer value (e.g., Pointer 1) is fetched which provides a location to a known protocol header in the frame header 310, such as by providing an address for the start of a specified protocol header 311. Using an “offset” value 312 and “extract size” value 313 provided by the FEC, a data field 314 may extracted from the frame header 310.

In other embodiments, the key extract command may be embodied as a generic extract command (GEC) contained in a key composition rule. A GEC has an explicit set of parameters specified in operands following it in the rule which define the same functional values as the FECs of the known frame header. Instead of accessing pointer values in frame header parse results 302, the executed GEC directly provides the location address or location to the known protocol header 311 in the frame header 310, thereby avoiding the requirement for generating parse result pointers. Using an “offset” value 312 and “extract size” value 313 provided by the GEC, a data field 314 may extracted from the frame header 310. The GEC can be used in a similar way to extract data fields from data structures other than a Frame Header, such as but not limited to the metadata associated with a Frame Header.

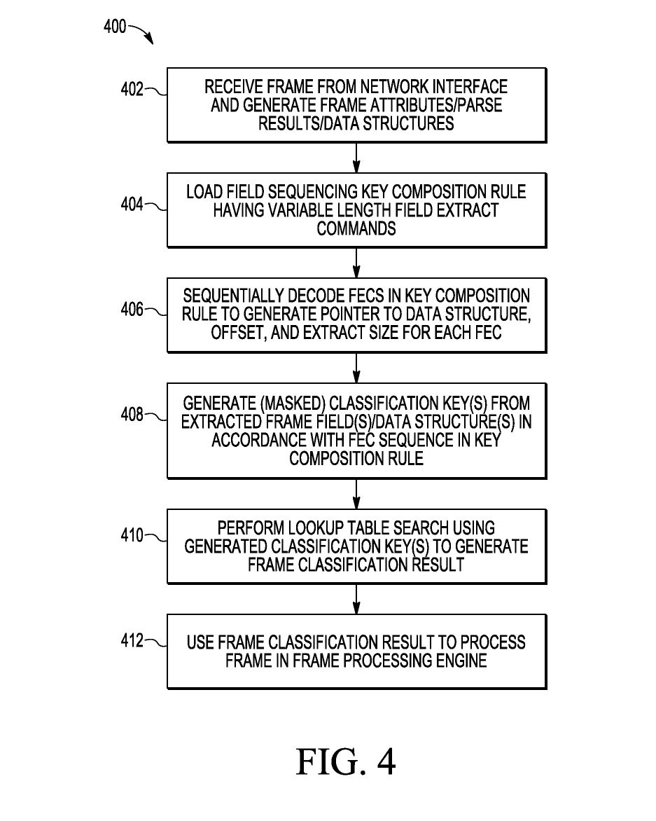

To provide additional contextual understanding for the present disclosure, reference is now made to FIG. 4 which illustrates a simplified process flow chart sequence for processing a frame in accordance with selected embodiments of the present disclosure. When the reception sequence starts (402), a network frame is received from the network interface. The frame can be received from various ports of a communication integrated circuit. Typically, lower layer processing, such as physical layer processing and even MAC layer processing, are applied in order to construct the frame. In many cases, a frame is sent to the communication integrated circuit in many packets. The physical layer and MAC layer processing reconstruct the frame. The frame can be received by a receive interface that can include some physical layer components, MAC layer components and the like. Upon reception, the frame is placed or stored in a receive buffer. In the example network frame processing classification system 100 shown in FIG. 1, the network frame may be stored in a register at the frame parser 105. The stored frame may then be parsed or otherwise processed to generate frame attributes, parse results, and/or other data structures.

At step 404, a key composition rule is retrieved from rule memory and loaded into a rule buffer. The load operation may be performed by a processor that can select and retrieve a key composition rule from memory storage using any desired technique. In accordance with the present disclosure, the loaded key composition rule may be a field sequencing key composition rule having a rule length field (NF) and one or more variable length field extract commands, each of which specifies data extraction information, such as such as the type of data being extracted, the method by which to calculate the location from which the data should be extracted, and the number of operands in the FEC. In the loaded key composition rule, one or more of the FECs may also include one or more additional mask operand values.

At step 406, the FECs in the loaded key composition rule are sequentially decoded to extract data from the frame header (e.g., source and destination IP addresses, source and destination transport layer ports, and transport protocol) and/or vector data values from other sources based on one or more FEC operands. The decode operation may be performed by hardware in the key generator engine 108, such as the rule decoder 112 and/or data extractor 110, which is configured with control logic or hardware circuitry to extract a data structure pointer, offset, and extract size in one or more operand values, alone or in combination with additional user-defined mask operand values. More generally, the FEC operands in each FEC are used to define and specify the type and location of each data field to be placed in the key under the control of the FEC. As a result, a first FEC may be executed to parse the network frame to extract first header data and/or vector data values as specified by the FEC operands in the first FEC, and then a second FEC may be executed to parse the network frame to extract second header data and/or vector data values as specified by the FEC operands in the second FEC, and so on until all FECs in the key composition rule are decoded.

At step 408, one or more classification keys are generated from the extracted frame fields, data structures, and/or vector data values in accordance with the FEC sequence in the key composition rule. The key generation operation may be performed by hardware in the key generator engine 108, such as the key generator 115, which is configured with control logic or hardware circuitry to generate a lookup or classification key by combining the extracted head/vector data values into an n-tuple as specified by the FEC operands in the sequence of one or more FECs in the key composition rule. The generated lookup or classification key may also have one or more specified masks applied to the generated sequence of frame fields and/or data structures in accordance with mask operand values and associated offset operand values from any FEC which designate masking locations with respect to the start of the extracted data.

At step 410, a lookup table search is performed using the lookup or classification key to generate a frame classification result for the network frame. The table lookup operation may be performed by processing functionality in the frame classification logic 128 which is configured with control logic or hardware circuitry to apply the lookup key as an input search term to the lookup table 129 in memory 130. The lookup result can be another classification key, a link to an interworking instruction, a link to another parse command, or any desired frame classification result.

At step 412, the network frame is processed based on the frame classification obtained from the table lookup results from step 410. This frame processing step may be performed by the frame processing engine 140 which is configured with control logic or hardware circuitry to process the network frame. Such processing may include routing, discarding, or diverting the frame in accordance with the matching LUT output results from the table 129. In addition, the frame processing results may include altering the network frame and placing the altered frame in a transmit buffer that is associated with a transmit buffer descriptor.

By now it should be appreciated that there is provided herein a hardware-based method and apparatus for classifying received network frames using lookup keys which contain data fields and which are generated from key composition rules having a header portion and a plurality of variable length key extract commands in a coded order sequence. The header portion specifies how many key extract commands are included in the key composition rule. In selected embodiments, at least one of the key extract commands is a field extract command for providing a pointer to a frame header parse result, an offset from a protocol header in the frame, and an extract size for extracting a data field from the frame. In other embodiments, at least one of the key extract commands is a generic extract command for providing a pointer to a protocol header in the frame, an offset from the protocol header in the frame, and an extract size for extracting a data field from the frame. The generic extract command can also point to a data structure other than a frame header. In the disclosed methodology, a frame is received and stored for processing. To process the frame, a first key composition rule is retrieved from memory and stored or loaded into a rule buffer, where the first key composition rule may include a plurality of key extract commands in a coded order sequence, and may also include a mask attribute which may be set to indicate application of one or more mask operands, and one or more mask operand values defining a mask and one or more mask offset values for applying the mask. A key generator accelerator hardware device generates a first data field from one or more operands contained in a first key extract command from the plurality of key extract commands, and also generates a second data field from one or more operands contained in a second key extract command from the plurality of key extract commands. In selected embodiments, the steps of generating the first and second data fields use pipelined hardware logic to extract the first and second data fields from the frame. A frame classification accelerator hardware device then looks up frame processing instructions from a lookup table memory using the lookup key to access a frame classification result for the frame.

In another form, there is disclosed a frame processing device which includes a network interface and key generation hardware engine. As disclosed, the network interface may be adapted to receive and output frames. In addition, the key generation hardware engine may be adapted to receive a first frame and a key composition rule which includes a plurality of variable length key extract commands in a coded order sequence and a header portion specifying how many variable length key extract commands are included in the key composition rule. In selected embodiments, the variable length key extract commands may include a variable length field extract command for extracting data from a header in the first frame, where the variable length field extract command includes a field extract command for providing a pointer to a frame header parse result, an offset from a protocol header in the first frame, and an extract size for extracting a data field from the first frame. In other embodiments, the variable length key extract commands may include a variable length generic extract command for extracting data from data structures associated with the first frame, such as metadata associated with a header in the first frame. In such embodiments, the variable length generic extract command may include a pointer to a protocol header in the first frame, an offset from the protocol header in the first frame, and an extract size for extracting a data field from the first frame or other data structure. In other embodiments, a variable length key extract command may include a mask attribute which may be set to indicate application of one or more mask operands and one or more mask operand values defining a mask and one or more mask offset values for applying the mask. To process the key composition rule, the key generation hardware engine may include a decoder, pipelined hardware logic, and a key generator. The decoder is adapted to sequentially decode each variable length key extract command to identify one or more data extract operands. The pipelined hardware logic is adapted to extract data from the first frame based on the one or more data extract operands decoded from each variable length key extract command. The key generator is adapted to generate a classification key by combining extracted data from each variable length key extract command in the same coded order sequence as the plurality of variable length key extract commands. The disclosed frame processing device may also include frame classification logic for looking up frame processing instructions from a lookup table using the classification key to access a frame classification result.

In another form, there is disclosed a network device having at least one processing device and at least one recordable storage medium having stored thereon executable instructions and data which, when executed by the at least one processing device, cause the at least one processing device to process a key composition rule stored in said at least one recordable storage medium to generate a lookup key. The key composition rule may be stored in memory with a data structure that is used for access by an application program being executed on a data processing system. To this end, the key composition rule may include a plurality of variable length key extract commands stored in a coded order sequence in said memory, each of said variable length key extract commands containing one or more data extract operands for extracting data from data structures associated with a network frame to generate a lookup key by sequentially combining data extracted under control of the plurality of variable length key extract commands in the same coded order sequence as the plurality of variable length key extract commands. The key composition rule data structure also includes a header portion specifying how many variable length key extract commands are included in the key composition rule. In selected embodiments, at least one of the variable length key extract commands includes a mask attribute which may be set to indicate application of one or more mask operands and one or more mask operand values defining a mask and one or more mask offset values for applying the mask.

Various illustrative embodiments of the present invention have been described in detail with reference to the accompanying figures. While various details are set forth in the foregoing description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are depicted with reference to simplified block diagrams and flow charts illustrating design and operational details of a data processing system for processing classification of network frames with associated hardware devices for processing network frames without including every device feature or aspect in order to avoid limiting or obscuring the present invention. Such descriptions and representations are used by those skilled in the art to describe and convey the substance of their work to others skilled in the art, and the omitted details which are well known are not considered necessary to teach one skilled in the art of how to make or use the present invention. Some portions of the detailed descriptions provided herein are also presented in terms of algorithms and instructions that operate on data that is stored in a computer memory. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of hardware or a computer system or a similar electronic computing device, that manipulates and transforms data represented as physical (electronic) quantities within registers and memories into other data similarly represented as physical quantities within the memories or registers or other such information storage, transmission or display devices.

Although the described exemplary embodiments disclosed herein are directed to various network data processing computer products, computing devices, and methodologies for processing network communications, the present invention is not necessarily limited to the example embodiments which illustrate inventive aspects of the present invention that are applicable to a wide variety of information processing systems and circuits. Thus, the particular embodiments disclosed above are illustrative only and should not be taken as limitations upon the present invention, as the invention may be modified and practiced in different but equivalent manners apparent to those skilled in the art having the benefit of the teachings herein. For example, although FIG. 1 and the discussion thereof describe an exemplary network frame classification architecture, this exemplary architecture is presented merely to provide a useful reference in discussing various aspects of the invention, and is not intended to be limiting so that persons of skill in the art will understand that the principles taught herein apply to other types of devices. For example, selected embodiments may implement the illustrated components of the data processing system 100 on a single integrated circuit or within a single device. Alternatively, data processing system 100 may include any number of separate integrated circuits or separate devices interconnected with each other. Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising.” or any other variation thereof, are intended to cover a non-exclusive inclusion, such that a process, method, article, or apparatus that comprises a list of elements does not include only those elements but may include other elements not expressly listed or inherent to such process, method, article, or apparatus. In addition, the term “coupled.” as used herein, is not intended to be limited to a direct coupling or a mechanical coupling. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method comprising:
retrieving from memory a first key composition rule comprising a plurality of key extract commands in a coded order sequence;
generating a first data field from one or more operands contained in a first key extract command from the plurality of key extract commands;
generating a second data field from one or more operands contained in a second key extract command from the plurality of key extract commands; and
generating a lookup key by combining the first data field and second data field in the same coded order sequence as the plurality of key extract commands.

2. The method of claim 1, where the key composition rule comprises a header portion specifying how many key extract commands are included in the key composition rule.

3. The method of claim 1, where one or more of the plurality of key extract commands comprises a field extract command for providing a pointer to a frame header parse result, an offset from a protocol header in a frame, and an extract size for extracting a data field from the frame.

4. The method of claim 1, where one or more of the plurality of key extract commands comprises a generic extract command for providing a pointer to a protocol header in a frame, an offset from the protocol header in the frame, and an extract size for extracting a data field from the frame or other data structure.

5. The method of claim 1, where each of the plurality of key extract commands comprises a variable length key extract command.

6. The method of claim 1, where at least one of the key extract commands comprises a mask attribute which may be set to indicate application of one or more mask operands.

7. The method of claim 6, where the at least one of the key extract commands further comprises one or more mask operand values defining a mask and one or more mask offset values for applying the mask.

8. The method of claim 1, where the steps of generating the first and second data fields use pipelined hardware logic to extract the first and second data fields from a frame.

9. The method of claim 1, further comprising looking up frame processing instructions from a lookup table using the lookup key to access a frame classification result.

10. A device for processing a frame, the device comprising:
a network interface adapted to receive and output frames; and
key generation hardware adapted to receive a first frame from the network interface and a key composition rule from memory, where the key composition rule comprises a plurality of variable length key extract commands in a coded order sequence, the key generation hardware comprising:
a decoder for sequentially decoding each variable length key extract command to identify one or more data extract operands,
pipelined hardware logic for extracting data from the first frame based on the one or more data extract operands decoded from each variable length key extract command, and
a key generator for generating a classification key by combining extracted data from each variable length key extract command in the same coded order sequence as the plurality of variable length key extract commands.

11. The device of claim 10, further comprising frame classification logic for looking up frame processing instructions from a lookup table using the classification key to access a frame classification result.

12. The device of claim 10, where the plurality of variable length key extract commands comprises a variable length field extract command for extracting data from a header in the first frame.

13. The device of claim 12, where the variable length field extract command comprises a field extract command for providing a pointer to a frame header parse result, an offset from a protocol header in the first frame, and an extract size for extracting a data field from the first frame.

14. The device of claim 10, where the plurality of variable length key extract commands comprises a variable length generic extract command for extracting data from data structures associated with the first frame, such as metadata associated with a header in the first frame.

15. The device of claim 14, where the variable length generic extract command comprises a pointer to a protocol header in the first frame, an offset from the protocol header in the first frame, and an extract size for extracting a data field from the first frame or other data structure.

16. The device of claim 10, where each key composition rule comprises a header portion specifying how many variable length key extract commands are included in the key composition rule.

17. The device of claim 10, where at least one of the variable length key extract commands comprises a mask attribute which may be set to indicate application of one or more mask operands.

18. The device of claim 17, where the at least one of the key extract commands further comprises one or more mask operand values defining a mask and one or more mask offset values for applying the mask.

19. A network device comprising at least one processing device and at least one recordable storage medium having stored thereon executable instructions and data which, when executed by the at least one processing device, cause the at least one processing device to process a key composition rule stored in said at least one recordable storage medium to generate a lookup key, said key composition rule comprising:
a plurality of variable length key extract commands stored in a coded order sequence in said at least one recordable storage medium, each of said variable length key extract commands containing one or more data extract operands for extracting data from one or more data structures associated with a network frame to generate the lookup key by sequentially combining data extracted under control of the plurality of variable length key extract commands in the same coded order sequence as the plurality of variable length key extract commands; and
a header portion specifying how many variable length key extract commands are included in the key composition rule.

20. The network device of claim 19, where at least one of the variable length key extract commands comprises a mask attribute which may be set to indicate application of one or more mask operands and one or more mask operand values defining a mask and one or more mask offset values for applying the mask.
